(19) United States
(12) Patent Application Publication
(10) Pub. No.: US 2009/0084507 A1
(43) Pub. Date: Apr. 2, 2009

(54) GARAGE DOOR VENTILATION ASSEMBLY

(76) Inventor: Daniel J. Tescher, Glendora, CA (US)

Correspondence Address: LOZA & LOZA LLP, 305 N. Second Avenue, #127, Upland, CA, 91786-6064, US

(21) Appl. No.: 11/863,181

(22) Filed: Sep. 27, 2007

(51) Int. Cl. E06B 7/02

(52) U.S. Cl. 160/44; 160/113

(57) ABSTRACT

A secure ventilation assembly for multi-panel retractable garage doors is provided. The ventilation assembly is comprised of a plurality of panels operably mounted to the multi-panel retractable garage door and movable between a retracted position and an extended position. The plurality of panels includes C-channel shaped frames sized to receive a soft wire mesh and a security barrier adjacent to the soft wire mesh for preventing debris and unwanted insects or rodents from entering the interior of the garage while still allowing air to flow into and out of the garage. The ventilation assembly may include a cooling system having a water absorbent breathable material that allows air to pass through and enter the interior of the garage. The material cools the air as the air evaporates water molecules from the material. As a result, cool air enters the interior of the garage cooling down the temperature of the interior.

### FIELD

The present invention relates to the field of multi-panel retractable garage doors, in particular, a garage door ventilation assembly for a multi-panel retractable garage door that allows air to pass into and out of the interior of a garage, while still providing a barrier to intruders, insects, debris and the like.

### BACKGROUND

Most garages, especially household garages, are not air conditioned and many lack windows resulting in poor ventilation. As a result, the inside of the garage tends to become quite hot, particularly during warm weather months. When the garage is attached to the house, this heat will transfer to the inside of the house resulting in increased electric bills as the air conditioner will need to be run to cool the house. Furthermore, many people have appliances in their garages, such as refrigerators and freezers. A poorly ventilated garage causes these appliances to work harder to maintain their constant temperatures, also resulting in increased electric bills for the occupants of the home.

Additionally, the interior of the garage accumulates automobile exhaust, which contains dangerous and cancer causing particles, as well as odors from trash or garbage stored within the garage. The exhaust and odors become trapped within the poorly ventilated garage and can find their way into the house and make for an unpleasant environment. Furthermore, in cold winter months, as garages are normally kept closed and many do not include windows, the interior of the garage typically remains dark and any moisture that accumulates can cause mold and mildew.

In one prior art approach for ventilating garages to overcome these problems, occupants typically leave the garage door open. However, for security reasons, the garage door cannot be left open unless someone is available to monitor the garage which is impractical or even impossible. Furthermore, leaving the door open to the garage permits debris, insects, rodents and other pests to enter.

In another prior art approach, portable screen panels similar to those used in windows and screen doors have been employed to improve garage ventilation. However, in order to install these panels, they must first be positioned between the bottom of the garage door and the floor of the garage. This can be a complicated and tedious task. Initially, the bottom of the garage door must be raised to a level above the screen panel. Then, the panel must be positioned in the garage door opening. While one person holds the panel, another person must lower the garage door until it engages the top of the panel to hold it into place. After the screen panel is removed, it must be stored in an appropriate location within the garage or elsewhere. In addition to being a tedious and time consuming task that requires at least two people, the screen must be installed each time it is to be used and must be removed whenever entry into the garage is desired.

Consequently, a garage door ventilation assembly is needed that is affixed to the multi-panel retractable garage door for easy operation and allows air to pass through while still providing a barrier to intruders, insects and debris.

### SUMMARY OF THE PRESENT INVENTION

In one embodiment a ventilation assembly for multi-panel retractable garage doors is provided. The ventilation assembly includes a plurality of panels operably mounted to the multi-panel retractable garage door and may be moved between a retracted position and an extended position. Each of the panels includes a screen assembly for preventing bugs, insects and the like from entering the garage and a security barrier for preventing intruders from gaining access to the garage. A release mechanism, such as a strap, is utilized to move the ventilation assembly between the retracted position and the extended position.

In yet another embodiment, the plurality of panels of the ventilation assembly for multi-panel retractable garage doors includes a water absorbent breathable material and a security barrier for preventing intruders from gaining access to the garage. As air passes through the water absorbent breathable material and enters the interior of a garage, the water absorbent breathable material cools the air as the air evaporates water molecules from the water absorbent breathable material.

In yet another embodiment, an evaporative cooler extracts water from a reservoir located within the ventilation and passes the water through a feed tube to a drip tube which drips water onto the water absorbent breathable material moistening it. The reservoir may be continually filled with water to maintain the cool air entering the interior of the garage.

The foregoing, together with other features and advantages of the present invention, will become more apparent when referring to the following specification, claims and accompanying drawings.

### BRIEF DESCRIPTION OF THE DRAWINGS

Various features of the present invention will be better understood from the following detailed description of an exemplary embodiment of the invention, taken in conjunction with the accompanying drawings in which like reference numerals refer to like parts.

FIG. 1 illustrates a fragmentary front view of a ventilation assembly, in an extended position, attached to a multi-panel retractable garage door in a closed position, according to one embodiment of the present invention;

FIG. 2 illustrates a fragmentary back view of a ventilation assembly in an extended position, attached to a multi-panel retractable garage door in a closed position, according to one embodiment of the present invention;

FIG. 3 illustrates a front perspective view of a ventilation assembly in a retracted position, attached to a multi-panel retractable garage door in an open position, according to one embodiment of the present invention;

FIG. 4 illustrates a rear perspective view of a garage door ventilation assembly in a retracted position, attached to a multi-panel retractable garage door in an open position, according to one embodiment of the present invention;

FIG. 5 illustrates a front perspective view of a screen panel, according to one embodiment of the present invention;

FIG. 6 illustrates a rear perspective view of a screen panel, according to one embodiment of the present invention;

FIG. 7 illustrates a cross section of a screen panel taken along the line 7-7 of FIG. 6;

FIG. 8 illustrates a front perspective view of a screen panel, according to one embodiment of the present invention;

FIG. 9 illustrates a front perspective view of a screen panel, according to one embodiment of the present invention;

FIG. 10 illustrates a front perspective view of a screen panel, according to one embodiment of the present invention;

FIG. 11 illustrates a front perspective view of a screen panel, according to one embodiment of the present invention;

FIG. 12 illustrates a front perspective view of a screen panel, according to one embodiment of the present invention;

FIG. 13 illustrates a side view of an electronic system for electronically extending and retracting a garage door ventilation assembly operably mounted to a multi-panel retractable garage door, according to one embodiment of the present invention;

FIG. 14 illustrates a channel locking mechanism for securing a garage door ventilation assembly to a garage floor, according to one embodiment of the present invention;

FIG. 15 illustrates a channel locking mechanism for securing a garage door ventilation assembly to a garage floor, according to one embodiment of the present invention;

FIG. 16 illustrates a front view of a drive mechanism for extending and retracting a garage door ventilation assembly, according to one aspect of the present invention; and

FIG. 17 illustrates a back view of a drive mechanism for extending and retracting a garage door ventilation assembly, according to one aspect of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

In the following description, certain terminology is used to describe certain features of one or more embodiments of the invention. The term “garage door” refers to any type of residential or commercial sectional garage door, i.e. a garage door comprising a plurality of horizontally extending panels (or sections) that are hinged to each other and roll up (or retract) when the garage door is opened. The term “connector” refers to any type of device for connecting metal, wood, plastic and other materials common in sectional door construction, including screws, bolts, nuts, washers, rivets, grommets, pins, clevis pins, studs, threaded rods and other mechanical fasteners as well as adhesives such as epoxy, welding joints such as spot welds and conventional fillet and butt joint welds. The term “retracted position” refers to the ventilation assembly is a stored or stowed position, i.e. the ventilation assembly is not in use and is folded inwards and secured to the back of a multi-panel retractable garage door. The term “extended position” refers to the ventilation assembly in a position causing the ventilation assembly to appear as an extension of the multi-panel retractable garage door, i.e. when the ventilation assembly is in use and no longer in the stowed position.

One aspect of the present invention provides a secure ventilation assembly for a multi-panel retractable garage door. The ventilation assembly may be attached to the bottom panel of the garage door or may be used to replace any of the panels in the garage door. Furthermore, it allows a garage to be secured from unwanted intrusion while still allowing for ventilation of the interior of the garage.

Conventionally, to ventilate a garage having a standard multi-panel retractable garage door, the garage door must remain open or at least partially open. As a result, intruders can easily enter the garage to steal items within the garage or to break into the house if the house can be accessed through the garage. By contrast, the garage door ventilation assembly of the present invention allows air to pass through the garage and yet still maintain security.

In one embodiment, the garage door ventilation assembly may include one or more fans for causing air to be blown into or sucked out of the interior of the garage, depending on which direction blades of the fan are rotating. In one embodiment the fans may be powered by a solar panel in the ventilation assembly. In another embodiment, the fans may be powered by electricity from the garage by using a retractable power cord running along the interior of the multi-panel retractable garage door.

In yet another embodiment, the ventilation assembly may include a cooling system having a water absorbent breathable material that allows air to pass through and enter the interior of the garage. The water absorbent breathable material cools the air as the air evaporates water molecules from the material. As a result, cool air enters the interior of the garage cooling down the temperature of the interior.

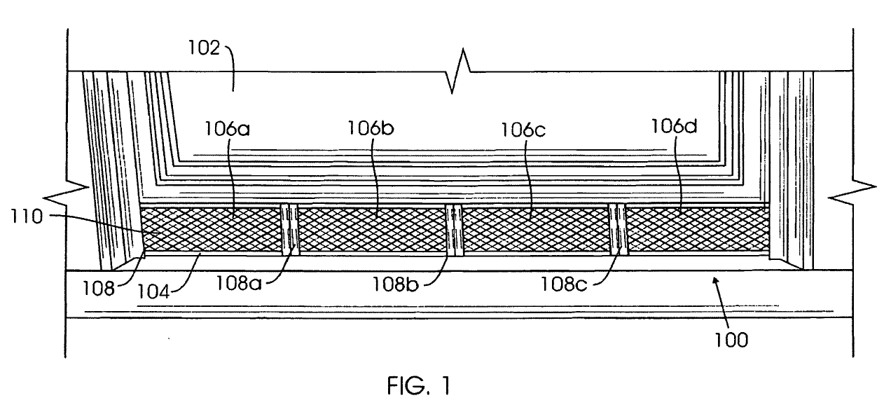

FIG. 1 illustrates a fragmentary front view of a garage door ventilation assembly 100, in a retracted position, operably mounted to a multi-panel retractable garage door 102 in a closed position, according to one embodiment of the present invention. It should be noted that only one panel of the multi-panel retractable garage door is shown in FIG. 1. Typically multi-panel retractable garage door include 4-5 separate panels.

The ventilation assembly 100 includes a plurality of screen panels 106a, 106b, 106c and 106d secured together by a plurality of connectors 108a, 108b, and 108c. In one embodiment, the connectors 108a, 108b, and 108c may be H-braces. Although four screen panels are illustrated in FIG. 1, the ventilation assembly 100 may comprise less than or more than four screen panels.

Although the ventilation assembly 100 in FIG. 1 is shown attached to the bottom panel of the multi-panel retractable garage door 102, the ventilation assembly 100 may be used to replace a panel of the multi-panel retractable garage door 102. The panel that is replaced may be the bottom panel, the top panel or any panel in between. Furthermore, the height of the ventilation assembly 100 may be varied. For example, the ventilation assembly 100 may be the exact same height as the panels in the multi-panel retractable garage door 102 so that consumers may be able to retrofit a currently installed multi-panel retractable garage door with the ventilation assembly of the present invention. The consumer merely has to remove one of the panels and replace it with the ventilation assembly 100. In one embodiment, the ventilation assembly 100 may replace a panel at the top of the multi-panel retractable garage door. As hot arise rises, replacing the top panel of the multi-panel garage door allows with the hot air within the garage to more easily escape. Furthermore, the width of the ventilation assembly may be the same width of a panel of the multi-panel retractable garage door or may have a width that is smaller or larger than the multi-panel retractable garage door.

Alternatively, the ventilation assembly 100 may be provided by the manufacturer of the multi-panel retractable garage door and installed when the garage door is installed. If the ventilation assembly comes as part of the multi-panel retractable garage door to be assembled, the height of the ventilation assembly may be selected by the homeowner. For example, the homeowner may opt to have a ventilation assembly that is the same height as the panel or may opt to have a ventilation assembly with a height that is larger or smaller than the panel. In yet another embodiment, more than one ventilation assembly may be included in the multi-panel retractable garage door. For example, two ventilation assemblies, which when combined may be the same height of one panel, may be inserted into the top and bottom, respectively, of the multi-panel garage door. This allows cold air to come in through the bottom ventilation assembly and hot air to escape through the top ventilation assembly. Alternatively, multiple ventilation assemblies in a multi-panel retractable garage door may be of any suitable height.

Each of the panels 106a, 106b, 106c and 106d includes a security barrier 108 made of a mesh screen of heavy gauge wire or heavy gauge perforated metal to make it difficult for an intruder to gain access to the interior of the garage. The security barrier 108 allows for ventilation and visibility. The mesh of the security barrier 108 may be formed in various manners. According to an embodiment of the invention, the mesh is formed of a metal or other material which provides sufficient strength to the screen to prevent accidental or intentional passage through the mesh. The mesh may include a network of interlinked strands that form a web-like structure with a multiplicity of small openings to provide a reasonable amount of visibility and air flow through the mesh. The strands may be interlinked in any known manner. As is known in the art, the strands may be woven or may be welded together to form the mesh. Preferably, when the mesh is formed, the material is strong enough to make the mesh rigid or nearly rigid. Such materials include metals (such as steel, chrome and/or aluminum), carbon composites, plastics and fiberglass. Other materials could be used which will provide the necessary rigidity. The rigid material provides safety in that it is extremely difficult to rupture from either the inside or the outside. Directly behind the security barrier 108 is a soft wire mesh 110 that can be used as a bug screen for preventing insects from entering the garage but yet still allowing air flow for ventilation.

As the ventilation assembly 100 may be the same size vertically as the panels of multi-panel retractable garage door, it remains securely in place and cannot be pulled outwardly so intruders and the like cannot gain access to the interior of the garage.

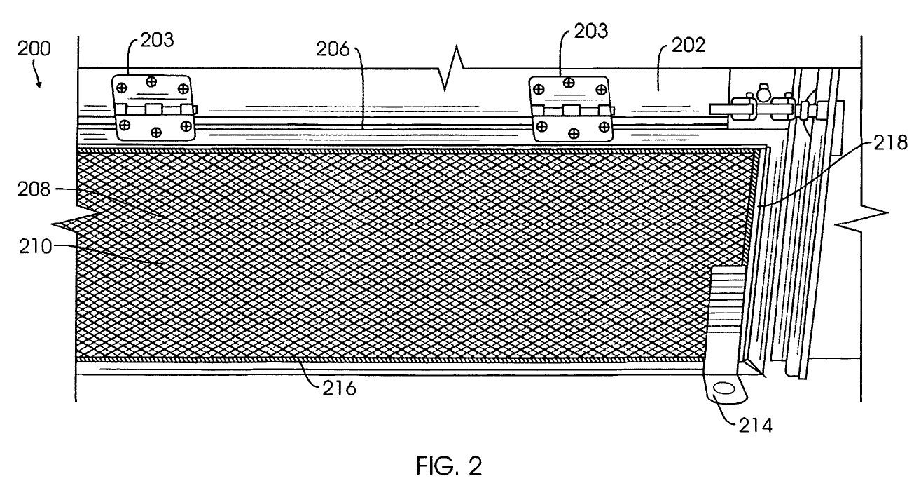

FIG. 2 illustrates a fragmentary back view of a panel 206 of a ventilation assembly 200 in a retracted position, operably mounted to a multi-panel retractable garage door 202 in a closed position, according to one embodiment of the present invention. The panel 206 of the ventilation assembly 200 is hingedly connected to the back of the multi-panel retractable garage door 202 by hinges 203. As described above, the panel 206 includes a security barrier 208 and a soft wire mesh 210. The soft wire mesh 210 is secured to a screen frame 218 by a spline 216 along the outer perimeter of the soft wire mesh 210. The panel 206 includes a C-channel shaped frame (described below) for housing the screen frame 218 and the security barrier 208.

To secure the soft wire mesh 210 to the screen frame 218, the soft wire mesh 210 is placed over the screen frame 218. The screen frame 218 has a groove (not shown) and the spline 216 is placed on top of the soft wire mesh 210 and pushed into the groove securing the soft wire mesh 210 to the screen frame 218 preventing the soft wire mesh 210 from detaching from the panel 206. If the soft wire mesh 210 becomes damaged, for example it is ripped or torn, or becomes dirty, the soft wire mesh 210 may be easily replaced by removing the spline 216, replacing the soft wire mesh 210 and securing it in place again with the spline 216.

A bracket 214, attached the back side of the panel 206, i.e. the side on the interior of the multi-panel retractable garage door 202, guides the ventilation assembly 200 into place as the multi-panel retractable garage door 202 is closed and secures it to the floor of the garage, preventing the ventilation assembly 200 from being pushed inwards into the interior of the garage. In one embodiment the bracket 214 may be an L bracket.

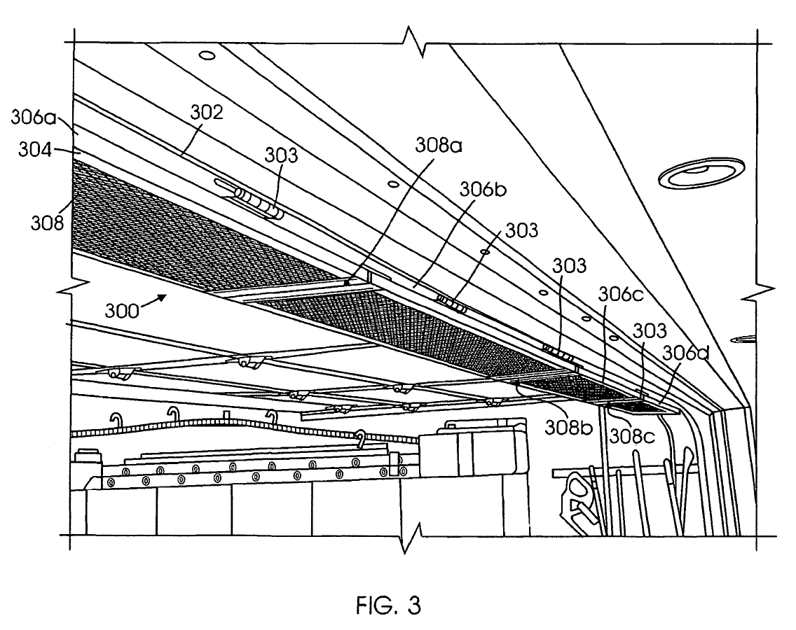

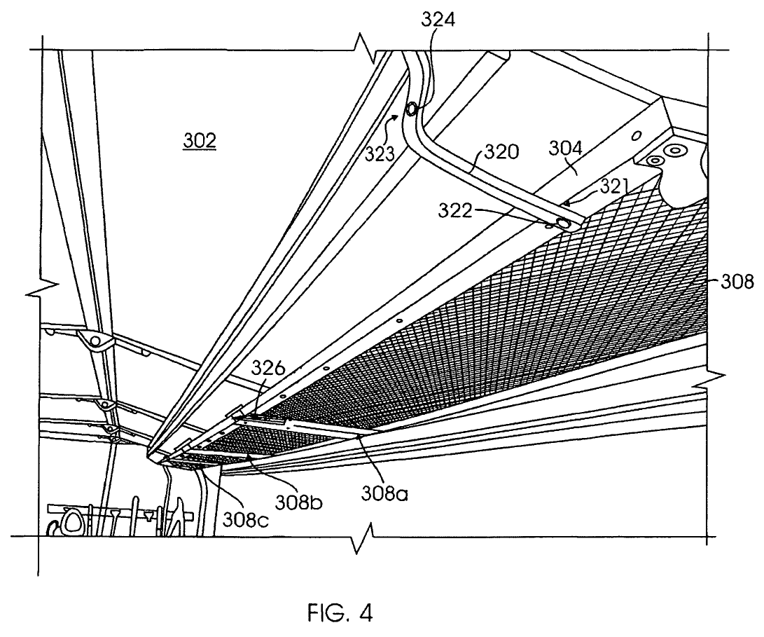

FIGS. 3-4 illustrate fragmentary rear perspective views of a ventilation assembly 300 in a retracted position, attached to a multi-panel retractable garage door 302 in an open position, according to one embodiment of the present invention. As described above, the ventilation assembly 300 includes a plurality of screen panels 306a, 306b, 306c and 306d secured together by a plurality of connectors 308a, 308b, and 308c. The ventilation assembly 300 is operably mounted to the multi-panel retractable garage door 302 by hinges 303. Each panel 306a, 306b, 306c and 306d of the ventilation assembly 300 includes a security barrier 308 and a soft wire mesh 310 as described above. In one embodiment, a strap 320 is used to secure the ventilation assembly 300 in the retracted position when not in use. A first end 321 of the strap 320 is fixedly attached to the ventilation assembly 300 using a connector 322, such as a grommet, and a second end 323 of the strap 320 is removably attached to the multi-panel retractable garage door 302 with a fastener 324, such as a screw. To move the ventilation assembly 300 from the retracted position to the extended position, the strap 320 is detached from the fastener 324 allowing the ventilation assembly 300 to move to the extended position.

In one embodiment, the ventilation assembly 300 includes a center bolt 326 secured to one of the panels of the ventilation assembly 300, preferably the center most panel. When the ventilation assembly 300 is in the extended position and the multi-panel retractable garage door 302 is closed, the center bolt may be lowered securing a middle portion of the ventilation assembly 300 to the floor of the garage to prevent the panels 306a, 306b, 306c and 306d from being pushed or forced inwards.

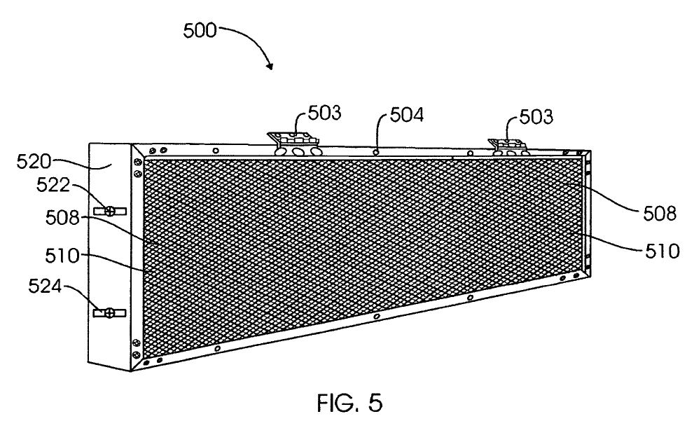

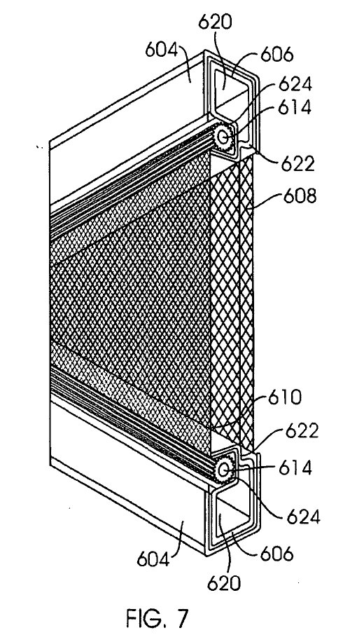

FIG. 5 illustrates a front perspective view of a screen panel 500, according to one embodiment of the present invention. The panel 500 includes a C-channel shaped frame 504 sized to receive a screen frame (described below with reference to FIG. 7) having a soft wire mesh 510, which can be used as a bug screen, directly behind a security barrier 508 (as described above). Hinges 503, attached to the frame 504, operably mount the panel 500 to a multi-panel retractable garage door.

As described above, the ventilation assembly of the present invention comprises a plurality of panels connected together. When the ventilation assembly is in the retracted position and the multi-panel retractable garage door is closed, there are gaps between the ventilation assembly and the track the garage door is operates on, the sides (or walls) of the garage, the floor of the garage and the bottom of the garage door. To fill these gaps and prevent debris and insects from entering the garage, side plates are mounted on the respective ends of the ventilation assembly.

In FIG. 5, a side plate 520 according to one embodiment of the present invention is illustrated. The side plate 520 includes first and second slots 522 and 525 for insertion of screws to secure the side plate 520 to the end of the panel 500 in the ventilation assembly.

In an alternative embodiment, the side plates may be mounted onto the side of the garage. The side plates may be constructed from various types of materials including, but not limited to, wood, metals (such as steel, chrome and/or aluminum), carbon composites, plastics and fiberglass.

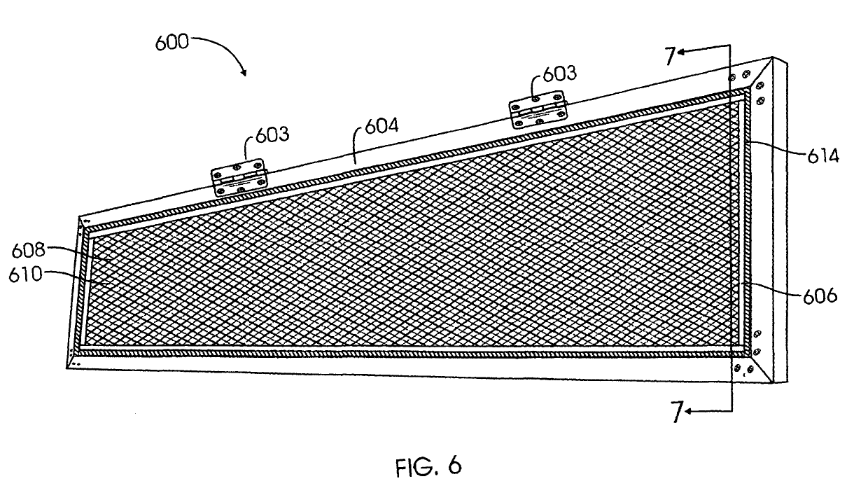

FIG. 6 illustrates a rear perspective view of a screen panel 600, according to one embodiment of the present invention. The panel 600 includes a C-channel shaped frame 604 sized to receive a screen frame 606 (described below with reference to FIG. 7) having a soft wire mesh 610, that can be used as a bug screen, behind a security barrier 608 (as described above). Hinges 603, attached to the C-channel shaped frame 604, operably mount the panel 600 to a multi-panel retractable garage door.

As described above, the soft wire mesh 610 is secured to a screen frame 606 by a spline 614 along the outer perimeter of the soft wire mesh 610. To secure the soft wire mesh 610 to the screen frame 606, the soft wire mesh 610 is placed over the screen frame 606. The screen frame 606 has a groove (not shown) and the spline 614 is placed on top of the soft wire mesh 610 and pushed into the groove securing the soft wire mesh 610 to the screen frame 606 preventing the soft wire mesh 610 from detaching from the panel 606. If the soft wire mesh 610 becomes damaged, for example it is ripped or torn, or dirty, the soft wire mesh 610 may be easily replaced by removing the spline 614, replacing the soft wire mesh 610 and securing it in place again with the spline 614.

FIG. 7 illustrates a cross section of the screen panel 600 taken along the line 7-7 of FIG. 6. A C-channel shaped frame 604 is sized to receive a screen frame 606 and a security barrier 608. The screen frame 606 includes a tubular portion 620 and (this is may be hollow or olid) a flange portion 622 extending from the tubular portion 620 (this is may be hollow or solid) creating a groove 624 for receiving edges of a soft wire mesh 610. The soft wire mesh 610 is placed over the screen frame 606 and pushed into the groove 624 and secured with the spline 614, preventing the soft wire mesh 610 from coming off. The soft wire mesh 610, for example, is a conventional fine mesh insect screen, that serves to prohibit bug penetration. The spline 614 may be made of any material known in the art, including but not limited to, a rigid strip of metal or plastic, or a flexible strip of rubber or plastic.

The screen frame 606 and security barrier 608 are inserted into the C-channel shaped frame 604 to form the screen panel 600. The C-channel shaped frame 604 is preferably fabricated from a rigid, lightweight, high-strength and corrosion-resistant material, such as metal, aluminum, aluminum alloy, stainless steel, and plastic.

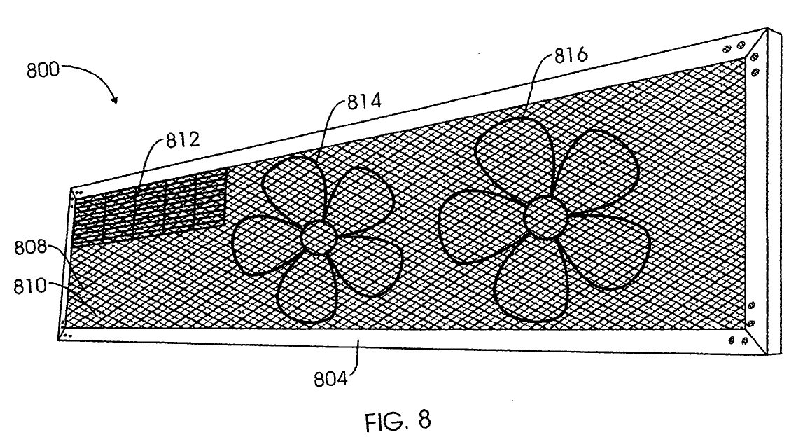

FIG. 8 illustrates a front perspective view of a screen panel 800, according to one embodiment of the present invention. The screen panel 800 includes a pair of fans 814 and 816 for causing air to be blown into or out of the interior of a garage, depending on which way the blades of the fans are rotating. In one embodiment, the fans 814 and 816 are powered by a solar panel 812 located within a portion of the panel 800. As with the panels described above, the panel 800 includes a soft wire mesh 810, which can be used as a bug screen, located directly behind a security barrier 808. The solar panel 812 may be secured to the front of the security barrier 808 or directly behind the security barrier 812. Openings in the security barrier 808, as described above, allow the sun to reach the solar panel 812 and generate the power needed to operate the fans 814 and 816. In an alternative embodiment, the fans 814 and 816 may be powered by electricity from the garage by using a retractable power cord running along the interior of the multi-panel retractable garage door for days when there is no sun.

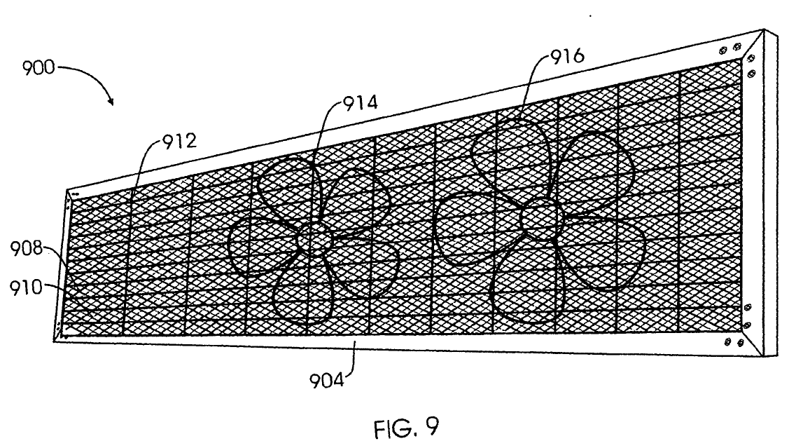

FIG. 9 illustrates a front perspective view of a screen panel 900, according to one embodiment of the present invention. As with the screen panel 800 in FIG. 8, the screen panel 900 has fans 914 and 916 for causing air to be blown into or out of the interior of a garage. The fans 914 and 916 are powered by a solar panel 912 located inside the panel 900 that extends across the entire surface of the panel 900 to generate more power than the smaller solar panel 812 of FIG. 8. The panel 900 includes a soft wire mesh 910, which can be used as a bug screen, located directly behind a security barrier 908. Openings in the security barrier 908, as described above, allow the sun to reach the solar panel 912 and generate the power needed to operate the fans 914 and 916. In an alternative embodiment, the fans 914 and 916 may be powered by electricity from the garage by using a retractable power cord running along the interior of the multi-panel retractable garage door for days when there is no sun.

Although two fans are shown in FIGS. 8 and 9, a single fan may be used or more than two fans may be used depending on the size of the garage.

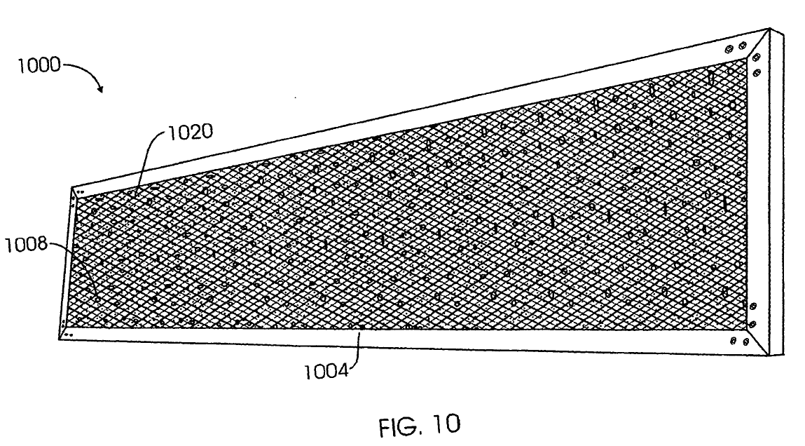

FIG. 10 illustrates a front perspective view of a screen panel 1000, according to one embodiment of the present invention. The panel 1000 includes a C-channel shaped frame 1004 sized to receive a water absorbent breathable material 1020 behind a security barrier 1008 (as described above). The water absorbent breathable material 1020 may be cooling pad that is made from a cellulose impregnated with a thermosetting resin, such as those made by Quietaire Corporation™ in Houston, Tex. The present invention is not limited to cooling pads made by Quietaire Corporation™ and any water absorbent breathable material may be used. The water absorbent breathable material 1020 is sized to the dimensions of the C-channel shaped frame 1004. As air passes through the water absorbent breathable material 1020 and enters the interior of the garage, the water absorbent breathable material 1020 cools the air as the air evaporates water molecules from the material 1020. As a result, cool air enters the interior of the garage cooling down the temperature of the interior. As the material 1020 is dense, a soft wire mesh is not needed to prevent bugs from entering. A fan (not shown) may be used to blow air through the water absorbent breathable material 1020.

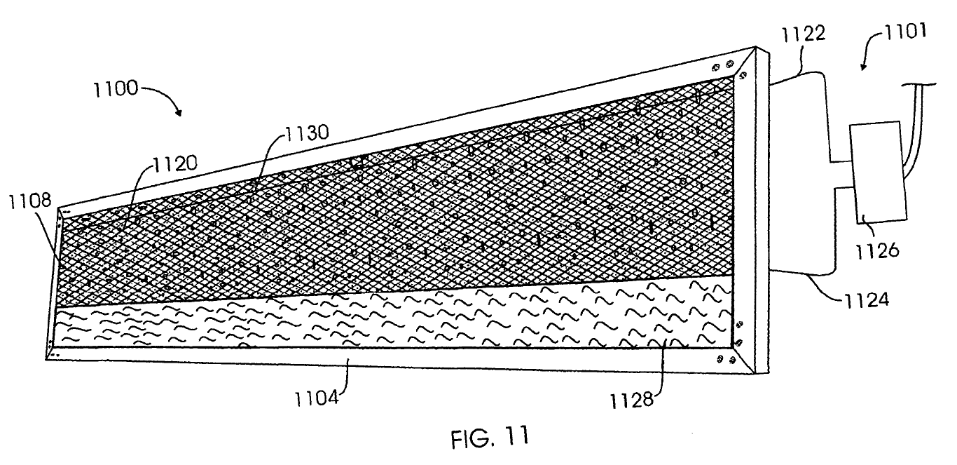

FIG. 11 illustrates a front perspective view of a screen panel 1100 connected to an evaporative cooler 1101, according to one embodiment of the present invention. The evaporative cooler 1101 comprises a pump 1126 for extracting water from a reservoir 1128. The pump 1126 then passes the water through a feed tube 1122 to a drip tube 1130 which drips water onto a water absorbent breathable material 1120 (as described above) moistening it. As air passes through the water absorbent breathable material 1120 and enters the interior of the garage, the water absorbent breathable material 1120 cools the air as the air evaporates water molecules from the material 1120. As a result, cool air enters the interior of the garage cooling down the temperature of the interior. As the water absorbent breathable material 1120 is dense, a soft wire mesh is not needed to prevent bugs from entering. The reservoir 1128 may be continually filled with water to maintain the cool air entering the interior of the garage. A fan (not shown) may be used to blow air through the water absorbent breathable material 1120.

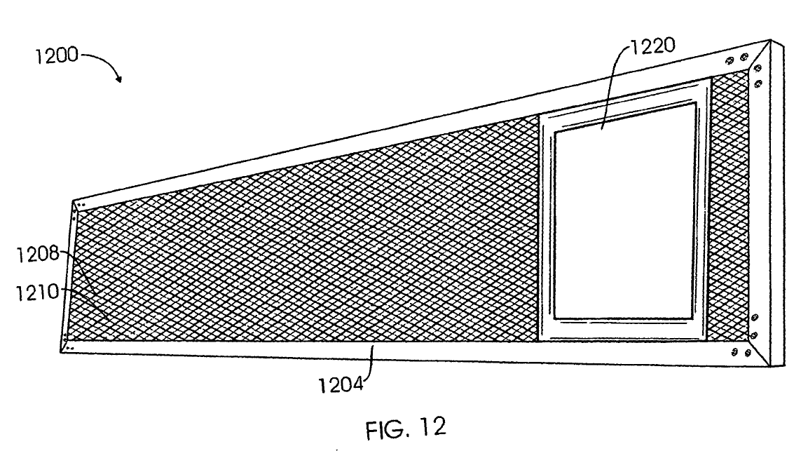

FIG. 12 illustrates a front perspective view of a screen panel 1200 having a pet door 1220, according to one embodiment of the present invention. The pet door 1220 can be of any size and allows a pet to gain access to the interior of the garage by walking through the pet door 1220. As described above, the panel 1200 includes a C-channel shaped frame 1204 sized to receive a screen frame (described above with reference to FIG. 7) having a soft wire mesh 1210, that can be used as a bug screen, behind a security barrier 1208 (as described above). For security purposes, the homeowners or occupants of the home can attach a transmitter to the collar of the pet(s) so only the homeowner's pet(s) may enter through the pet door 1220. A receiver on the pet door 1220 receives a signal from the collar of the pet which causes the pet door 1220 to unlock allowing the animal to enter.

FIG. 13 illustrates a side view of an electronic system 1300 for electronically extending and retracting a garage door ventilation assembly 1312, according to one embodiment of the present invention. A motorized device 1316 hangs near the center of the ceiling in a garage for providing power, through a power cord 1318, to a controller 1306. The controller 1306 is attached to the multi-panel retractable garage door 1302 and to a guide rail 1304. A cable 1320, having a first end attached to the controller 1306 and a second end attached to a top of the multi-panel retractable garage door 1302, causes the multi-panel retractable garage door 1302 to open and close as the controller 1306 traverses the guide rail 1304. When the controller 1306 traverses the rail 1304, it also sends a signal to a servo 1308, having an output shaft attached to the ventilation assembly 1312 and a base unit attached to the multi-panel retractable garage door 1302, via an expandable transmission line 1310, instructing the ventilation assembly 1312 to automatically move between the retracted and extended positions, depending on the direction in which the controller 1306 is traversing the guide rail 1304.

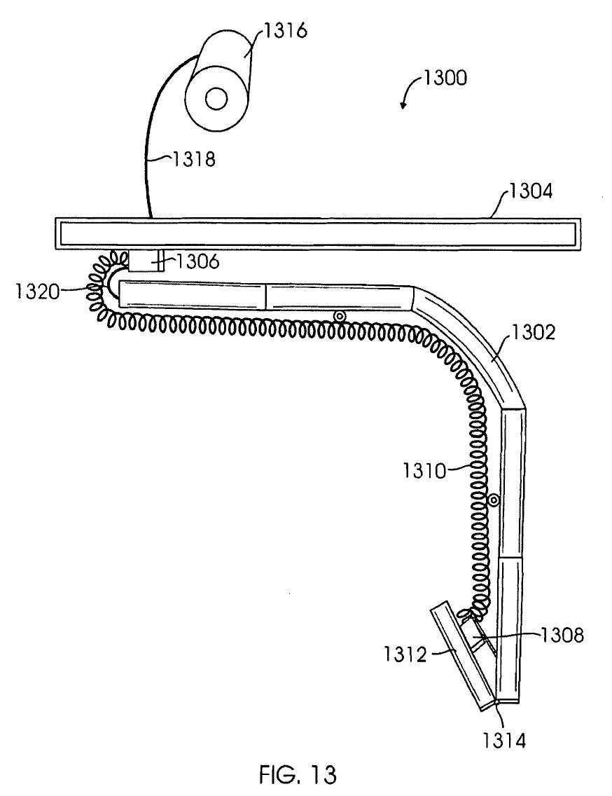

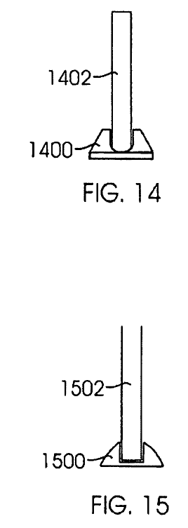

FIG. 14 illustrates a channel locking mechanism for securing a garage door ventilation assembly to a garage floor, according to one embodiment of the present invention. A channel 1400, for securing the ventilation assembly 1402 in place, is affixed to the floor of a garage. As the multi-panel retractable garage door is lowered with the ventilation assembly 1402 in an extended position, the elongated rectangular channel 1400 receives the bottom of the ventilation assembly 1402 securing it in place and preventing it from being pushed inwards or outwards. The channel 1400 may be made of any material, including but not limited to, rubber, metal and plastic.

FIG. 15 illustrates a channel locking mechanism for securing a garage door ventilation assembly to a garage floor, according to one embodiment of the present invention. An elongated oval channel 1500, for securing the ventilation assembly 1502 in place, is affixed to the floor of a garage. As the multi-panel retractable garage door is lowered with the ventilation assembly 1502 in an extended position, the elongated oval channel 1500 receives the bottom of the ventilation assembly 1502 securing it in place. The elongated channel 1500 may be made of any material, including but not limited to, rubber, metal and plastic.

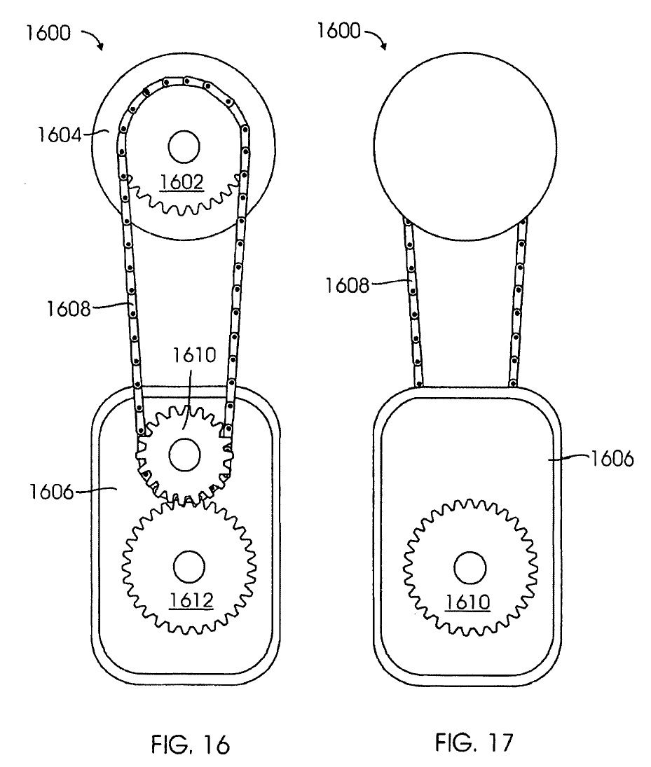

FIGS. 16 and 17 illustrate front and back views, respectively, of a drive mechanism 1600 for extending and retracting a ventilation assembly, according to one embodiment of the present invention. The drive mechanism 1600 is mounted on one side of the garage near the ventilation assembly. The drive mechanism 1600 includes a door spring shaft 1604, which is turned by a main drive gear 1602, for commanding coil springs (not shown), wound around the spring door shaft 1604 to displace elastically as the ventilation assembly is closed or retracted. The spring gear 1602 is operatively connected to a gear assembly 1606 by a chain 1608. The gear assembly 1606 includes a first gear 1610 and a second gear 1612 for selectively rotating the spring gear 1602 in both a clockwise direction, for closing or retracting the ventilation assembly, and a counter-clockwise direction for opening or extending the ventilation assembly. Counter-rotation of the first and second gears 1610 and 1612 drivingly rotate the main drive gear 1602 in the same direction as the first gear 1610.

The gear assembly 1606 may include a series of spokes on a wheel attached to the gear closest to the garage door. The spokes rotate and when the spokes contact a lever (not shown) on the ventilation assembly, the ventilation assembly automatically lowers (or rises). Gas shocks may be placed onto the ventilation assembly to allow the speed in which the ventilation assembly moves between the retracted position and the extended position, and vice versa, to be controlled.

One or more of the components and functions illustrated in FIGS. 1, 2, 3, 4, 5, 6, 7, 8, 9, 10, 11, 12, 13, 14, 15, 16 and/or 17 may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. A ventilation assembly for multi-panel retractable garage doors, comprising:
at least one panel operably mounted to a multi-panel retractable garage door movable between a retracted position and an extended position, the at least one panel comprising:
a screen assembly;
a security barrier adjacent the screen assembly; and
a frame sized to receive the screen assembly and the security barrier;
a release mechanism having a first end secured to the at least one panel and a second end secured to the multi-panel retractable garage door for moving the at least one panel between the retracted position and the extended position.

2. The assembly of claim 1, wherein the security barrier is a rigid mesh having a plurality of openings that permit air to flow into a garage for ventilation.

3. The assembly of claim 1, further comprising a bracket attached to one of the at least one panels for guiding the one of the at least one panels into a channel lock secured to the floor of the garage for preventing the one of the at least one panels from being pushed inward.

4. The assembly of claim 1, wherein the release mechanism is a strap having a first end fixedly attached to a bottom portion of the at least one panel and a second end removably attached to the multi-panel retractable garage door to secure the at least one panel in the retracted position when not in use.

5. The assembly of claim 4, wherein releasing the strap causes the at least one panel to move from the retracted position to the extended position.

6. The assembly of claim 1, further comprising at least one fan secured to a back side of the security barrier for blowing air into or out of the interior of a garage.

7. The assembly of claim 6, wherein the at least one fan is powered by a solar panel secured to the back side of the security barrier.

8. The assembly of claim 7, wherein openings in the security barrier allow sun to come into contact with the solar panel generating power.

9. The assembly of claim 6, wherein the at least one fan is powered by electricity from the garage using a retractable power cord running along the interior of the multi-panel retractable garage.

10. The assembly of claim 1, wherein the release mechanism is an electronic system for automatically extending and retracting the multi-panel retractable garage door and the at least one panel, the electronic system comprising:
a cable having a first end attached to a controller, secured to a guide rail attached to the ceiling of a garage, and a second end attached to a top of the multi-panel retractable garage door; wherein as the controller traverses the guide rail the cable causes the multi-panel retractable garage door to open and close; and
a servo having an output shaft attached to the at least one panel for automatically moving the at least one panel between the retracted and extended positions as the multi-panel retractable garage door opens and closes and a base unit attached to the multi-panel retractable garage door, wherein the servo is attached to the controller via a transmission line and wherein the controller sends a signal to the servo via the transmission line instructing the at least one panel to move between the retracted and extended positions.

11. A ventilation assembly for multi-panel retractable garage doors, comprising:
at least one panel operably mounted to a multi-panel retractable garage door movable between a retracted position and an extended position, the at least one panel comprising:
a water absorbent breathable material;
a security barrier adjacent the water absorbent breathable material; and
a frame sized to receive the water absorbent breathable material and the security barrier; and
a release mechanism having a first end secured to the at least one panel and a second end secured to the multi-panel retractable garage door for moving the at least one panel between the retracted position and the extended position.

12. The assembly of claim 11, wherein as air passes through the water absorbent breathable material and enters the interior of a garage, the water absorbent breathable material cools the air as the air evaporates water molecules from the water absorbent breathable material.

13. The assembly of claim 11, further comprising an evaporative cooler connected to the at least one panel for cooling air that enters the interior of a garage.

14. The assembly of claim 13, wherein the at least one panel further comprises a water reservoir secured to a back side of the security barrier for supplying water to the evaporative cooler.

15. The assembly of claim 14, wherein the evaporative cooler supplies water to a drip tube secured to the water absorbent breathable material which drips water onto the water absorbent breathable material causing the water absorbent material to become wet.

16. The assembly of claim 15, wherein the wet water absorbent material cools air entering the garage as the air evaporates water molecules from the water absorbent breathable material.

17. The assembly of claim 11, wherein the security barrier is a rigid mesh having a plurality of openings that permit air to flow into a garage for ventilation.

18. The assembly of claim 11, wherein the release mechanism is a strap having a first end fixedly attached to a bottom portion of the at least one panel and a second end removably attached to the multi-panel retractable garage door to secure the at least one panel in the retracted position when not in use.

19. The assembly of claim 18, wherein releasing the strap causes the at least one panel to move from the retracted position to the extended position.

20. A ventilation assembly for multi-panel retractable garage doors, comprising:
means for allowing air to flow into and out of a garage having a multi-panel retractable garage door when the a multi-panel retractable garage door is in a closed position; and
means for preventing insects and debris from entering into the garage.
